(19) United States
(12) Patent Application Publication
(10) Pub. No.: US 2026/0196764 A1
(43) Pub. Date: Jul. 9, 2026

(54) PROTECTIVE DEVICE FOR SEALING A PLUG CONNECTION

(71) Applicant: HARTING Electronics GmbH, Espelkamp (DE)

(72) Inventor: Maximilian ROHRER, Bielefeld (DE)

(73) Assignee: HARTING Electronics GmbH, Espelkamp (DE)

(21) Appl. No.: 19/132,840

(22) PCT Filed: Nov. 14, 2023
(86) PCT No.: PCT/DE2023/100871

§ 371 Date: May 26, 2025

(30) Foreign Application Priority Data
Nov. 28, 2022 (DE) 10 2022 131 364.6

(51) Int. Cl. H01R 13/52

(52) U.S. Cl. CPC H01R 13/5213

(57) ABSTRACT

A protective device (2) for sealing a plug connection consisting of a plug connector and a mating connector should be inexpensive and easy to manufacture. Preferably, it should be easy to retrofit the plug connection, when already installed/assembled, with the protective device (2). The protective device (2) is in the form of a single-piece protective cover (2). It consists of an elastic material, e.g. rubber, and is substantially tubular in shape, i.e. it is open on both sides and-apart from these two openings-sealed around its circumference. In particular, the protective cover (2) can be turned inside out so that it can be pulled over the already assembled plug connector from the plug-side direction, i.e. folded back. Preferably, the shape of the protective cover (2) may correspond to the outer contour of the plug connector.

### CROSS-REFERENCE TO RELATED APPLICATION

This application is a national stage application, filed under 35 U.S.C. § 371, of International Patent Application PCT/DE2023/100871, filed on Nov. 14, 2023, which claims the benefit of German Patent Application DE 10 2022 131 364.6, filed on Nov. 28, 2022.

### TECHNICAL FIELD

The disclosure presents a protective device for sealing a plug connection. The disclosure also relates to a system comprising the protective device according, a cable, and a plug connection, in particular a plug connection which is primarily used for signal transmission, for example an RJ45 or ix industrial plug connection or the like. Furthermore, the disclosure presents a method for using the protective device with a plug connection of the aforementioned type. Such protective devices are needed in order to protect plug connections against dirt, dust and moisture.

### BACKGROUND

EP 1 413 013 B1 shows a multipart protective device for a plug connection.

The disadvantage is that the production and assembly of this protective device is very complicated. Furthermore, it is not possible to retrofit this known protective device known from the prior art to already installed and thus pre-configured plug connectors. However, this may become necessary if, following the installation, it transpires that the protective action of a plug connection is inadequate, for example because the environmental conditions worsen and the requirements on the tightness thus rise accordingly. One disadvantage consequence thereof consists in the associated outlay and the corresponding loss of time, for example in the production sequence of an industrial production plant, if old plug connections have to be replaced by new plug connections.

The German Patent and Trademark Office has searched the following prior art in the priority application relating to the present application: DE 18 74 556 U, US 2013/0337670 A1, U.S. Pat. No. 3,167,374 A, AU 1992 022 080 A1, CN 112 864 700 A and CN 202 308 562 U.

### SUMMARY

An object of the disclosure is a protective device for sealing a plug connection, wherein it should be possible to produce the protective device as inexpensively and simple as possible. In particular, it should be easily possible to retrofit already existing plug connections with the protective device, preferably when they are already installed.

The plug connection can be, for example, a plug connection which is primarily used for signal transmission, therefore, for example, an RJ45 or ix industrial plug connection or the like.

The object is achieved by the subject matter of the independent claims.

A protective device for sealing a plug connection is formed in one piece as a protective cover. It consists of an elastic, watertight material, for example rubber, preferably latex, and is substantially tubular, i.e. it is open on both sides and circumferentially closed between these two openings to make the seal.

The plug connection has a plug connector and a mating connector in particular designed as a circuit board connector, wherein the plug connector can be plugged into the mating connector. The term circuit board connector is to be understood here as a plug connector which can be mounted on a circuit board. The circuit board can be arranged in a device housing. The circuit board connector can then be connected to a plug connector outside the device through a wall aperture in a housing wall of the device housing. The plug connection can therefore be used in particular in device connection technology.

The protective device has the advantage of sealing the plug connector and in particular also the plug connection simply and inexpensively. In particular, already existing cabling with plug connectors already connected (“pre-configured”), can be retrofitted quickly and simply.

Advantageous refinements of the invention are specified in the sub-claims and the following description.

The protective device has the advantage that it can be produced with only little outlay.

The protective device in particular has the advantage that it can be produced automatically easily and inexpensively.

In addition, the protective device has the advantage that it can be pulled retrospectively over an already pre-configured (“assembled”), plug connector, i.e. one connected to the connection side of a cable. In particular in fixed installations, this permits retrospective improvement of the protection against dust, dirt and moisture. This further has the advantage that, in particular, already installed power and signal distribution systems can be retrofitted simply and quickly and thus no or comparatively only very short outage times of the associated plant, for example an industrial production plant, arise.

In other words, the protective device has the particular advantage that it can also be pulled onto an already installed and therefore already pre-configured plug connector. Pre-configured means that a cable connection side is already connected to the plug connector, i.e. electrically conductively connected to its plug contacts on the connection side, for example by soldering, screwing, crimping, clamping via a clamping spring or else via soldering to conductor tracks of a circuit board internal to the plug connector. In the case of fixed cabling, in which the cables are even led through passage holes of device or room walls and are permanently installed, pulling the protective cover (protective device) onto the plug from the plug side is of particularly great advantage.

An additional advantage consists in the fact that the relevant plug connectors can already have existed for a long time on the market, in particular already over a time period of several years or even decades. The plug connector and the plug connection, having the plug connector and the mating connector, can be qualified by means of the retrospectively produced protective device to a higher IP (“international protection”) protective class with respect to damaging environmental influences such as foreign bodies (dust) and water (moisture) than originally envisaged, which is designated “sealing” here for reasons of simplicity. This additional, simply retrofittable seal in particular constitutes a particularly great advantage for RJ45 plug connectors or comparable plug connectors, since these plug connectors, although historically they initially originate from the analog telecommunications sector, are now more and more frequently used in industrial application areas. For this use in the industrial environment, they must satisfy both high requirements on the transmission performance, that is to say, for example, on the data rate and the data integrity, but are often also subjected to rough environmental conditions. Frequently, the necessity for a retrofit reveals itself only when the installation has already been carried out.

Finally, the plug connectors in such cases are already connected to fixed cabling, i.e. pre-configured (“assembled”). Therefore, in such cases, the ability to be retrofitted uncomplicatedly and quickly by means of the protective device/protective cover is of quite special advantage. Otherwise-by contrast-a conventional procedure will consist in retrospectively exchanging all the plug connections of the plant with plug connections of a higher IP protective class. This conventional procedure would however, in addition to increased material costs, also result in considerable outage times of the plant, for example an industrial production plant, and therefore corresponding competitive disadvantages. It is easy to see that such outage times of the cabling, for example within an industrial production plant, are highly undesirable.

Furthermore, there may be the problem that, in the case of fixed cabling, the length of the individual cables is dimensioned so exactly that replacement of the existing plug connector, which is normally also associated with a certain shortening of the cable lengths, is even no longer possible. In this case, too, the protective device is therefore of special advantage, since the existing plug connectors can be sealed off adequately by the protective cover and therefore do not have to be replaced at all.

But even for newly produced plug connectors, particularly high protection against dust and moisture can be achieved inexpensively by the protective cover. This can possibly also simplify the customer logistics.

A further additional advantage consists in the fact that the plug connector is better protected against impacts by the elasticity of the protective cover.

Furthermore, the protective cover, in particular in the plugged-in state, can lead to a higher vibration resistance, i.e. protect the plug connector against vibrations when it is plugged into a vibrating machine tool.

In a preferred refinement, the protective device can have an opening each at two opposite ends, therefore a total of two openings, namely a cable connection-side opening on a cable connection-side end and a plug-side opening on its plug-side end.

This is advantageous, since the protective device (protective cover) can thus enclose the plug connector but leaves its plug-in area free to be plugged in through the plug-side opening. At the same time, it is made possible to lead the connected cable out through the cable connection side opening.

In a preferred refinement, the protective cover (protective device) can be invertible. In this connection, the term “invert” is to be understood in the sense of interchanging the inner and outer sides. This inverting action has the advantage that, when it is inverted, i.e. when its inner side is turned outward and its outer side is turned inward, it can be drawn very simply over the plug connector from the plug-side direction. The cover can then also rest closely on the plug connector, preferably enclose the latter with a force fit and in particular exhibit adhesive friction with respect to the plug connector. Finally, in this way the protective cover even does not need to slide over the plug connector but is simply turned back over the plug connector as it is pulled on.

For this purpose, the initially inverted protective cover can be plugged with its plug-side opening onto the plug-in area of the pre-configured plug connector and moved with its cable connection-side end and its cable connection-side opening over the plug-in area-and therefore over its own plug-side end. The inner side of the protective cover, until this point in time still directed at least partly outward, can be laid in particular with a force-fit on the surface of the plug connector and, as the cable connection-side end of the protective cover is pulled further over the plug connector, can turn inward to an increasing proportion, and therefore the outer side can be turned outward again to the same extent. This turning back is particularly advantageous since the protective cover can firstly be pulled onto the plug connector with little manual effort and, at the same, also adapts elastically to its outer contour. It is also particularly advantageous if the shape of the protective cover corresponds to the outer contour of the plug connector.

In particular, after that the protective cover can enclose the plug connector with a form and force fit and in particular even exhibit the aforesaid adhesive friction relative to the surface of the plug connector without this being detrimental to its ease of use. Ultimately, the-now re-inverted-protective cover not only encloses the plug connector and therefore also its cable connection area in a sealing manner but also the cable led out of the plug connector housing through the cable connection area.

A method is used to use the protective device with the already pre-configured and/or already installed plug connection and (as already mentioned above) provides that in its inverted state, when its inner side is arranged on the outside and its outer side is arranged on the inside, the protective cover is pulled on the plug side onto a plug connector of the plug connection, as a result of which the aforesaid inner side of the protective cover lies on the surface of the plug connector and is turned inward as the protective cover is pulled over the plug connector and the outer side is turned outward.

As a result the cable-connection side end of the protective cover pulled onto the plug connector can enclose the cable connection area of the plug connector in a sealing manner and also a cable already connected to the plug connector and led out through this cable connection area.

At its plug-side end, the protective device can additionally have a sealing molding on its outer side. The sealing molding can in particular have an outwardly directed radial seal, for example in the form of one or more circumferential sealing rings or sealing lamellae. Alternatively or additionally, the sealing molding can have a sealing lip, for example projecting in the plug direction, which is in particular designed as a flat seal. This is particularly advantageous since, as it is plugged into the mating connector, in particular into a mating connector which is designed as a circuit board plug connector and is installed in a device, an effective and inexpensive plug-side seal is thus provided. The sealing molding can preferably be a constituent part of the single-piece protective cover and can thus consist of the same material.

The plug connector can be plugged into the mating connector through the plug-side opening, the protective cover sealing off the plug connector with respect to the mating connector and/or the device housing with its plug-side end and in particular with the sealing molding preferably formed thereon.

A system has the protective device, the plug connector and the mating connector and also a cable which is connected to the plug connector. The protective device can enclose a cable connection area of the plug connector on the cable connection side in a sealing manner, and also a cable led through the cable connection area and out through the cable connection-side opening of the protective device. Furthermore, the protective cover can also seal off the plug connector with respect to the mating connector plugged into the same and/or the device housing.

The shape of the protective cover which-as already mentioned-forms the protective device can correspond to the outer contour of the plug connector. To this end, at least the protective cover can be configured to adapt elastically to the outer contour of the plug connector.

By means of the elastic protective cover, flexible “rubberization” (specialist jargon) is advantageously provided to achieve a higher sealing action for a plug connection to be retrofitted. As previously described, the protective cover can be pulled retrospectively over the already pre-configured (“assembled”) plug connector.

Furthermore, the rubberization of the plug connector ensures a particularly leakproof connection to the device housing in which the mating connector is installed.

To simplify the operation, the protective cover can be supplied to the customer/user by the manufacturer in the already inverted state. From the inverted state, the protective cover, as described above, can be pulled in a particularly easy-to-use manner over the plug side of the already pre-configured plug connector and turned back in the process.

As already mentioned, a plug-side opening can also be provided opposite the cable connection-side opening in the protective cover. This plug-side opening is used to expose a connector face of the plug connector in order that it can be plugged into the mating connector. In a preferred configuration, this plug-side opening in the protective cover is somewhat smaller than the connector face of the plug connector, in order to implement the best possible sealing. Furthermore, the material of the protective cover can be reinforced somewhat in this area, for example in the form of an end ring, which is implemented in the plug-side end of the protective cover, and encloses the plug-side opening to close it. This is advantageous since, as a result, the formation of cracks in the protective cover during the in particular multiple use is reliably prevented. In addition, particularly good retention of the protective cover on the plug connector is ensured as a result.

The protective cover can have a sufficiently high elasticity at its cable connection-side end, at least in the area of the cable/cable connection area, in order to ensure that the protective cover advantageously nestles particularly snugly in a sealing manner on the cable surface. Also in this area, the protective cover can have a particularly high material thickness for the aforementioned reasons and/or have a closing cable connection-side closing ring. Furthermore, this has the advantage that the protective cover can be turned back non-destructively over the plug connector.

The system can be configured in such a way that the locking and unlocking mechanism between the plug connector and the mating connector has sufficient play to accommodate the sealing molding. The locking and unlocking mechanism, on the one hand, and the sealing molding of the protective cover, on the other hand, can be matched to one another in this way.

The protective cover thus advantageously protects not only the plug connector itself but, when plugged in, also enables the sealing transition between the plug connector and the mating connector and/or the device housing in which the mating connector, preferably implemented as a surface mounting connector, is installed.

As already mentioned, the latter can particularly advantageously be done by the aforesaid sealing molding molded onto the plug-side end of the protective cover, for example a sealing lip (e.g. with a surface seal) or else a radial seal (e.g. at least one circumferential sealing ring).

In the plug connection, there can be a small gap between the plug connector and the mating connector and/or the housing wall in which the mating connector is installed. For example, this gap makes the plugging action between the plug connector provided with the protective cover and the mating connector possible, in particular when the protective cover has the aforesaid plug-side sealing lip. This sealing lip can preferably be designed as a surface seal. This has the advantage that it ends with a comparatively large area on a flat portion of a mating connector, and therefore seals particularly securely and well. By means of the locking, a sealing contact pressure can be implemented, the sealing lip preferably applying an elastic opposing force.

Alternatively or additionally, a radial seal in the form of the aforesaid circumferential sealing ring or circumferential sealing lamellae can also be provided on the plug-side end portion of the protective cover. As a result, even in the event of a gap that is not sufficiently large, it is possible to seal off the plug connection to the outside by the plug connector being plugged partly into the device housing or at least into the wall aperture in the housing wall.

A further advantageous configuration provides the single-piece integration of a magnet into the plug-side end of the protective cover. As a result, in addition to improving the sealing action, additional retention/detachable locking of the plug connection can advantageously also be implemented. This can have the additional advantage that the connection between plug connector and mating connector is signaled to the user both haptically and acoustically.

As already mentioned, the protective cover can have the shape of the outer contour of the respective plug connector. Such a protective cover can be produced by a mold or negative mold of the respective plug connector being created and then being sprayed with or dipped in the elastic material. In order to reinforce specific areas, as mentioned before, or even to implement closing rings or sealing moldings, the mold can be dipped/sprayed many times at the appropriate points or sprayed over a correspondingly longer time period, or the like.

In a preferred refinement, further elements, e.g. separate sealing rings or plastic rings for stabilization, can be introduced into the protective cover during production, for example injection-molded in or cast in or the like.

In a further advantageous refinement, RFID chips/RFID transponders can also be embedded in the protective cover in order to equip an existing plug connection with the RFID chip/the RFID transponder retrospectively-as an additional advantageous secondary effect without great additional effort.

### BRIEF DESCRIPTION OF THE DRAWINGS

An exemplary embodiment of the invention is illustrated in the drawings and is explained in more detail below.

Fig. la shows a first plug connector;

FIG. 1b shows a first protective cover;

FIG. 1c shows the first plug connector with the first protective cover pulled on;

FIG. 2a shows a second plug connector;

FIG. 2b shows a second protective cover;

FIG. 2c shows the second plug connector with the second protective cover pulled on;

FIG. 3a shows a plug connection comprising the second plug connector and a mating connector installed in a device housing;

FIG. 3b, c show the second plug connector with the second protective cover pulled on, having a sealing lip;

FIG. 3d shows the second plug connector with the second protective cover pulled on, having a radial sealing ring.

### DETAILED DESCRIPTION

The figures contain partly simplified schematic illustrations. To some extent, identical designations are used for the same but possibly non-identical elements.

Different views of the same elements can be scaled differently. Directional statements such as, for example, “left”, “right”, “top” and “bottom” are to be understood with reference to the respective figure and can vary with respect to the illustrated object in the individual illustrations.

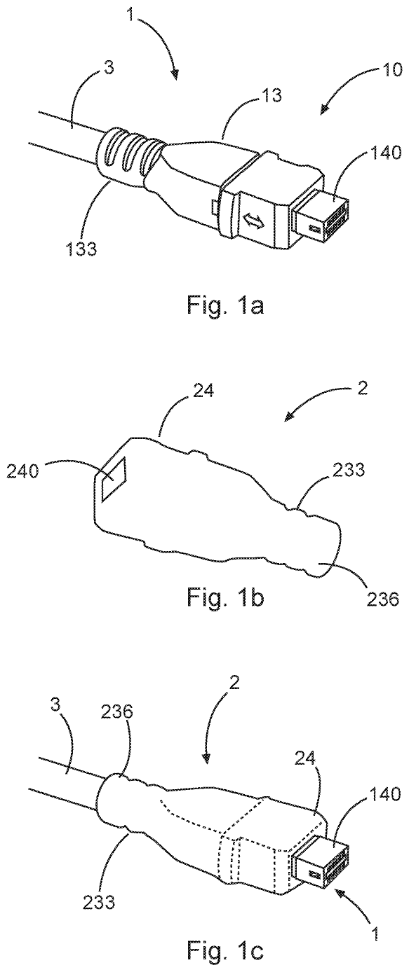

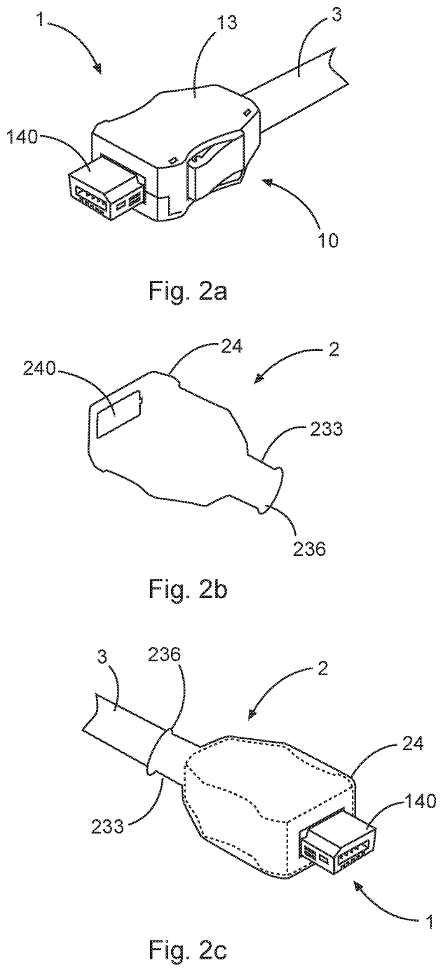

FIGS. 1a and 2a each show a first and second plug connector 1. This plug connector 1, which in this example is a respective ix industrial plug connector, in each case has a plug connector housing 10 with a cable connection area 13, through which a cable 3 can be led from outside into the plug connector 1 and, within the respective plug connector housing 10, is connected to plug contacts, not shown here, of the plug connector 1. “Connected” in this connection means that individual wires of the cable 3 are electrically conductively connected to the respective plug contacts of the plug connector 1.

The cable connection area 13 of the first plug connector 1 additionally has a cable outlet 133, which has a braid-like structure in order, firstly, to be more flexible than the housing 10 but, secondly, to act in a sufficiently stabilizing manner as an anti-kink protector on the cable 3 led through.

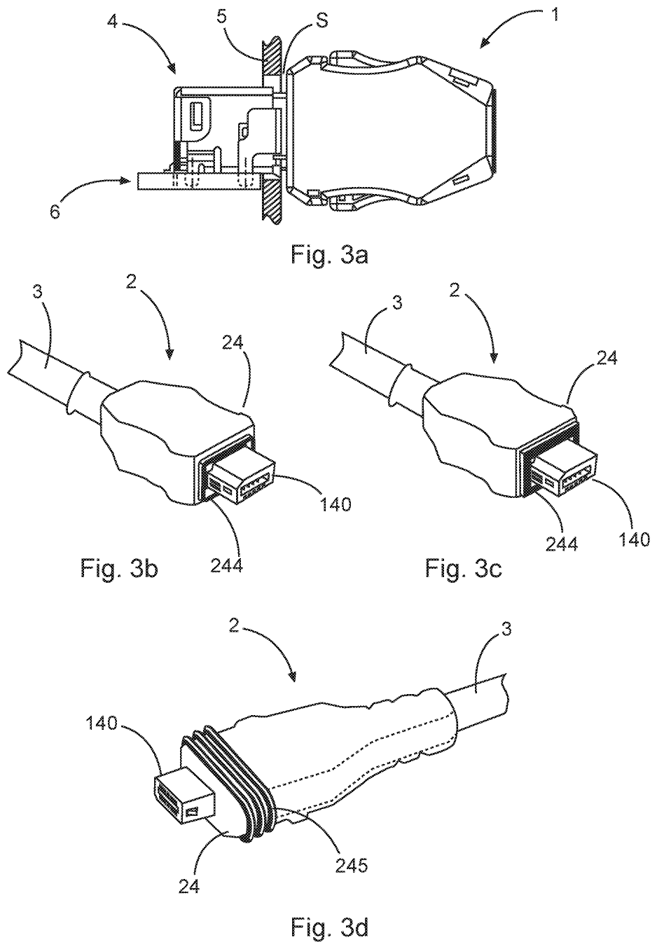

Opposite its cable connection area 13, each of the two plug connectors 1 has a plug area 140 for plugged electrical connection to mating contacts of a mating connector 4 shown in FIG. 3a.

FIGS. 1b and 2b each show a protective device 2, which is designed as a first and second protective cover 2. As can easily be seen, each of these two protective covers 2 has the shape of the outer contour of the respective first and second plug connector 1. Each of the two protective covers 2 consists of a flexible, watertight material, for example rubber, and is formed in one piece and in a substantially tubular shape. In this connection, tubular means that the protective cover 2 is open on both sides and is circumferentially closed between these openings to make the seal.

As its end 24 on the plug side, the protective cover 2 thus has a plug-side opening 240. Opposite the plug-side opening 240, the protective cover 2 has a cable connection-side opening, which cannot be seen in the drawing because it is hidden visually by the cable connection-side end portion 233 of the protective cover 2. At the end, the protective cover 2 has at its cable connection-side end 233 an annular cable seal 236, which encloses the aforementioned cable connection-side opening that is not shown. The annular cable seal 236 is formed by a material thickening of the protective cover 2. In the case of non-round cable cross sections, an appropriately adapted cable seal is also conceivable.

FIGS. 1c and 2c show the first and second plug connector 1 with respectively fitted protective cover 2. The protective cover 2 is preferably fitted by simply pulling over the plug connector 1. In the process, the plug area 140 of the respective plug connector 1 penetrates the plug-side opening 240 of the protective cover 2. The annular cable seal 236 encloses the cable 3 in a sealing manner.

FIG. 3 illustrates the plug-side sealing concept of the protective cover 2.

FIG. 3a shows in a sectional illustration the housing wall 5 of a device housing in which the mating connector 4, which is designed as a circuit board connector, is installed. On the connection side, the mating connector 4, which is an ix industrial socket connector, is soldered to a circuit board 6, i.e. its mating contacts have connection areas which are electrically conductively connected to conductor tracks of the circuit board 6 and are also mechanically connected to the circuit board 6. Thus, the mating connector 4 is additionally a circuit board connector.

By way of example, in this illustration the second plug connector 1 is plugged into the mating connector 4 without a protective cover 2. Of course, this could also be the first plug connector 1. There is a gap S between the housing wall 5 and the second plug connector 1 shown here by way of example.

FIGS. 3b and 3c show the second plug connector (not explicitly provided with a designation here) with the protective cover 2 pulled over it. On the plug side, the protective cover 2 has a respective sealing molding in the form of a sealing lip 244, wherein the sealing lip 244 shown in FIG. 3a is rather narrow and the sealing lip 244 shown in FIG. 3c is wide and flat, which increases the sealing action. When plugged in, this plug-side sealing lip 244 fills the aforementioned gap S and encloses a mating plug area of the mating connector 4. In this way, the plug connection, comprising the first plug connector 1 and the mating connector 4, is sealed off to the outside by the protective cover 2.

As an alternative variant, FIG. 3d shows a sealing molding in the form of a radial seal, which is designed here as a plurality of sealing rings 245. In an alternative embodiment, these can also be sealing lamellae.

When the plug connector 1 is plugged into the mating connector 4, the radial seal 245 seals the plug connector 1 with respect to the mating connector 4 and/or the housing wall 5, and also seals the plug connection to the outside.

### LIST OF DESIGNATIONS

1 Plug connector
10 Plug connector housing
13 Cable connection area
133 Cable outlet
140 Plug-in area
2 Protective device/protective cover
233 Cable connection-side end/cable connection-side end portion
236 Cable seal
24 Plug-side end/plug-side end portion
240 Plug-side opening
244 Sealing lip
245 Radial seal/sealing ring(s)
3 Cable
4 Mating connector
5 Housing wall
6 Circuit board
S Gap

1.-15. (canceled)

16. A protective device (2) for sealing a plug connection,
wherein the protective device (2) is a one piece protective cover,
wherein the protective device (2) consists of an elastic material, and
wherein the protective device (2) is substantially tubular.

17. The protective device (2) as claimed in claim 16,
wherein the protective device (2) has two mutually opposite ends (24, 233), namely a plug-side end (24) and a cable connection-side end (233),
wherein a respective opening is arranged at each of the two mutually opposite ends (24, 233), namely a cable connection-side opening arranged at the cable connection-side end (233), and a plug-side opening (240) arranged at the plug-side end (24).

18. The protective device (2) as claimed in claim 17,
wherein the protective device (2) is configured to be inverted in order to be pulled over a pre-configured plug connector (1) from a plug-side direction in an inverted state and turned back while being pulled.

19. The protective device (2) as claimed in claim 18,
wherein the plug-side end (24) of the protective device (2) has a sealing molding (244, 245) on an outside.

20. The protective device (2) as claimed in claim 19,
wherein the sealing molding is an outwardly directed radial seal including one or more circumferential sealing rings (245) or sealing lamellae.

21. The protective device (2) as claimed in claim 19,
wherein the sealing molding is a flat seal including a sealing lip (244) projecting in a plug-in direction.

22. A system, comprising:
a cable (3);
a plug connector (1);
a mating connector (4); and
the protective device (2) as claimed in claim 17,
wherein the protective device (2) encloses the plug connector (1) in a sealing manner.

23. The system as claimed in claim 22,
wherein the cable (3) is connected to the plug connector (1), so that the plug connector (1) is in a pre-configured state, and
wherein the protective device (2) sealingly encloses
a connection side of a cable connection area (13) of the plug connector (1), and
the cable (3) led through the cable connection area (13) and out of the plug connector (1) through the cable connection-side opening of the protective device (2).

24. The system as claimed in claim 22,
wherein the plug connector (1) and the mating connector (4) are configured for signal transmission.

25. The system as claimed in claim 22,
wherein a shape of the protective device (2) corresponds to an outer contour of the plug connector (1) or
wherein a shape of the protective device (2) is configured to adapt elastically to the outer contour of the plug connector (1) during use with the plug connection.

26. The system as claimed in claim 22,
wherein the protective device (2) exposes a plug-in area (140) of the plug connector (1) with the plug-side opening (240) to be plugged into the mating connector (4), and
wherein the protective device (2), when plugged in, seals off the plug connector (1) in the plug-in area (140) relative to the mating connector (4) with the plug-side end (24).

27. A method, comprising:
providing the protective device (2) as claimed in claim 18;
inverting the protective device (2) so that an inner side faces outwards and an outer side faces inwards;
pulling the protective device (2) onto a plug connector (1) of the plug connection; and
pressing the inner side of the protective device (2) on a surface of the plug connector (1) and turning the protective device (2) right-side-out while pulling the protective device (2) over the plug connector (1), thereby returning the outer side of the protective device (2) to facing outward.

28. The method as claimed in claim 27, further comprising:
pulling the cable connection-side end (233) of the protective device (2) onto the plug connector (1) and enclosing a cable connection area (13) of the plug connector (1) and a cable (3) connected to the plug connector (1) in a sealing manner.

29. The method as claimed in claim 27, further comprising:
enclosing the plug connector (1) with a form and force fit by the protective device (2).

30. The method as claimed in claim 27, further comprising:
plugging the plug connector (1) into a mating connector (4) by the plug-in area (140) projecting through the plug-side opening (240) of the protective device (2), and
sealing off the plug connector (1) against the mating connector (4) by the plug-side end (24) of the protective device (2).
